(19) United States
(12) Patent Application Publication
(10) Pub. No.: US 2012/0154260 A1
(43) Pub. Date: Jun. 21, 2012

(54) Driving LED's

(75) Inventors: Alain Decraemer, Brugge (BE); Erik De Meersman, Bruges (BE)

(73) Assignee: KONINKLIJKE PHILIPS ELECTRONICS N.V., Eindhoven (NL)

(21) Appl. No.: 13/390,744

(22) PCT Filed: Sep. 2, 2010
(86) PCT No.: PCT/IB2010/053939

§ 371 Date: Feb. 16, 2012

(30) Foreign Application Priority Data
Sep. 9, 2009 (EP) 09169801.9

(51) Int. Cl. G09G 3/32; H05B 37/00

(52) U.S. Cl. 345/82; 315/193; 315/185 R

(57) ABSTRACT

A drive circuit (DR) drives a plurality of LED strings (DS1, DS2; DS10) each comprising at least one LED (Di). The drive circuit comprises a resonance inductor (K1), and a plurality of branches which each comprise a series arrangement of a resonance capacitor (C31, C32; C34, C35) and an associated one of the plurality of LED strings (DS1, DS2; DS10). The resonance capacitor (C31, C32; C34, C35) is arranged between the resonance inductor (K1) and its associated one of the plurality of LED strings (DS1, DS2; DS10) to receive a resonance voltage (VAC) from the resonance inductor (K1). A level and frequency of the resonance voltage (VAC) and an impedance of the resonance capacitor (C31, C32; C34, C35) are selected to obtain a current source supplying a LED current (IL1 IL2; IL10) through the associated one of the plurality of LED strings (DS1, DS2; DS10) which is substantially independent on a tolerance on forward voltages of LED's of the associated one of the plurality of LED strings (DS1, DS2; DS10).

### FIELD OF THE INVENTION

The invention relates to a drive circuit for driving a plurality of LED strings each comprising at least one LED (Light Emitting Diode). The invention further relates to a LED circuit comprising the drive circuit and the LED strings, to a backlight unit for a display apparatus, and to a display apparatus comprising a display panel and the backlight unit.

### BACKGROUND OF THE INVENTION

WO 2007/060129 A2 discloses a driving arrangement for feeding a current generated by a high frequency generator to a plurality of LED cells each including at least one LED. The driving arrangement includes a respective plurality of LED channels arranged in a parallel configuration and one or more coupled inductors coupling in pairs the plurality of LED channels. The coupled inductors in the channels perform current equalization of LED currents even in the presence of very different forward voltages in the channels.

When applying a high frequency voltage source to a pair of LED channels wherein the string of LED's exhibits a different forward voltage and wherein the LED channels are coupled with a coupled inductor, the unbalanced magnetic flux in the core of the coupled inductor determines a dynamic impedance that tends to compensate the different LED forward voltages by substantially exerting a negative feedback action.

This approach has the drawback that a large number of coupled inductors is required to counteract the tolerances on the forward voltages of the LED's.

### SUMMARY OF THE INVENTION

It is an object of the invention to provide a drive circuit for driving a plurality of LED strings to counteract the tolerances on the forward voltages of the LED's without requiring coupled inductors for every string.

A first aspect of the invention provides a drive circuit for driving a plurality of LED strings as claimed in claim 1. A second aspect of the invention provides a LED circuit comprising the drive circuit and the LED strings as is claimed in claim 11. A third aspect of the invention provides a backlight unit for a display apparatus wherein the backlight unit comprises the LED circuit as is claimed in claim 12. A fourth aspect of the invention provides a display apparatus comprising a display panel and the backlight unit for illuminating the display panel as is claimed in claim 13. Advantageous embodiments are defined in the dependent claims.

A drive circuit in accordance with the first aspect of the invention drives a plurality of LED strings which each comprise at least one LED. The drive circuit comprises a resonance inductor which resonates with a plurality of resonance capacitors. A plurality of branches each comprises one of the resonance capacitors and an associated one of the LED strings. The resonance capacitor is arranged between the resonance inductor and the one of the plurality of LED strings associated with the resonance capacitor. The LED string which is associated with the resonance capacitor in that they both are within the same branch will be referred to as the associated LED string. Although, it is said that one resonance capacitor is arranged in series with its associated LED string, it should be understood that this one resonance capacitor may comprise several parallel and/or series arranged lumped capacitors. With LED string is intended to define a single LED or a plurality of LED's which are arranged in series. The resonance inductor supplies a resonance voltage to the plurality of resonance capacitors. Because for each one of the plurality of branches, a resonance capacitor is arranged in series with its associated LED string, all these series arrangements of resonance capacitors and associated LED strings receive the resonance voltage from the resonance inductor.

A level and frequency of the resonance voltage and an impedance of the resonance capacitor of each branch are selected to obtain a current source for the LED's of the associated LED string. Such a current source supplies a current through the associated one of the plurality of LED strings which is substantially independent on a tolerance on forward voltages of LED's of the associated LED string.

Thus, the plurality of coupled inductors disclosed in WO 2007/060129 A2 is not anymore required. This prior art relies on the effect that when different currents flow through the coupled inductor, a voltage drops across the inductors of the coupled inductor are caused which cover for the different forward voltage of the strings of LED's and equalizes the currents. In contrast, the present invention connects the branches to the resonance inductor without the coupled inductors and selects the resonance voltage and the impedance of the resonance capacitors sufficiently high with respect to the forward voltage of the string of LED's such that a current source behavior results. This current source or current source behavior need not be ideal. It suffices that the influence of the tolerance of the forward voltage of the LED's is decreased.

In an embodiment, the drive circuit comprises a power converter which supplies an AC supply voltage to the resonance inductor. Any power converter which converts either the AC mains or a DC voltage supplied by a battery or obtained by rectifying the AC mains voltage into an DC voltage may be used. For example, as is well known, the power converter may comprise a series arrangement of electronic switches which series arrangement receives a DC voltage. The junction of the series arranged electronic switches is connected to the inductor. The switches are controlled such that their on and off states alternate in a non-overlapping manner to supply an AC voltage to the inductor.

In an embodiment, each one of the LED strings comprises the same number of LED's, the resonance capacitances all have the same value and all are connected to the resonance inductor.

In an embodiment, in every branch, a rectifier circuit is arranged between the resonance capacitor and its associated LED string.

In an embodiment, an electronic switch is coupled to a junction of the resonance capacitor and its associated LED string to withdraw at least a portion of the LED current out of the branch. This enables to selectively control the current through the LED strings, which, for example, may be relevant if the a white color point of the light generated by strings of differently colored LED's has to be controlled.

In an embodiment, all the resonance capacitors receive the same common resonance voltage. Different types of LED strings, for example for generating light having different colors, may receive different resonance voltages from different resonance inductors or from different windings of a resonance transformer. Alternatively, all or a subset of the branches may receive the same resonance voltage from the same resonance inductor to obtain a minimal complexity of the drive circuit.

In an embodiment, the power converter has an input which enables to influence the AC power supply voltage. In this manner it is possible to control the LED current through the LED strings, which may be relevant if the intensity of all LED strings has to be controlled, for example to control the white level displayed.

In an embodiment, the drive circuit comprises a control circuit which receives a video signal to be displayed on a display panel illuminated by the LED strings. The control circuit has an output coupled to the input of the power converter to control the LED current in response to the video signal. This has the advantage that the luminance of the displayed image can be controlled in response to the content of the video signal, for example to limit the power consumption for images with a high content of high luminance white or for improving the black level for images with a low content of high luminance white.

In an embodiment, the control circuit reduces the LED current when a white content in a picture represented by the video signal exceeds a predetermined level, or increases the LED current when a white content in a picture represented by the video signal drops below a predetermined level. The first mentioned predetermined level and the later mentioned predetermined level may be identical or may differ.

In an embodiment, the drive circuit comprises a feedback circuit with a feedback capacitor, an impedance and a rectifier circuit. The feedback capacitor is one of the plurality of resonance capacitors. The impedance supplies a feedback signal representative of a current through the impedance. The rectifier circuit is arranged between the feedback capacitor and the impedance. Thus, because the feedback capacitor is one of the resonance capacitors, also this capacitor receives the resonance voltage from the resonance inductor. Consequently, the current through the series arrangement of the feedback capacitor, the rectifier circuit and the impedance is an image of the current flowing through the LED strings. The power converter comprises a control circuit to regulate the AC power supply voltage supplied by the power converter to the resonance inductor in response to the feedback signal.

In an embodiment, the drive circuit comprises a further control circuit which receives a video signal to be displayed on a display panel illuminated by the LED strings. This further control circuit is coupled to influence the feedback signal to control the current through the LED strings in response to the video signal. The modulating of the feedback signal with video signal information is an easy manner to influence the LED current through the LED strings in response to a property of the video signal.

In an embodiment, the further control circuit reduces the LED current when a white content in a picture represented by the video signal exceeds a predetermined level, or increases the LED current when a white content in a picture represented by the video signal drops below a predetermined level.

These and other aspects of the invention are apparent from and will be elucidated with reference to the embodiments described hereinafter.

### BRIEF DESCRIPTION OF THE DRAWINGS

In the drawings:

FIG. 1 schematically shows a high level block diagram of a display apparatus,

FIG. 2 shows a circuit diagram of an embodiment of a power converter, a drive circuit for driving LED strings and the LED strings, and

FIG. 3 shows an alternative topology of one of the branches comprising a LED string and its association part of the drive circuit.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

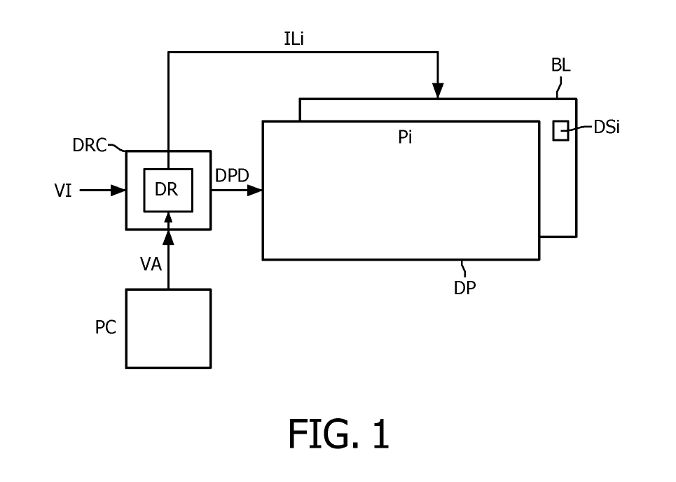

FIG. 1 schematically shows a high level block diagram of a display apparatus. The display apparatus comprises a backlight unit BL, a display panel DP, a drive circuit DRC and a power converter PC.

The backlight unit BL comprises the strings of LED's. Only one string DSi of the strings of LED's is shown. The display panel DP comprises pixels Pi (not explicitly shown) which usually are arranged in a matrix of rows and columns. The power converter PC supplies a power supply voltage to the drive circuit DR. The power converter PC may be fed by the mains or by a battery. The processing circuit DRC generates drive signals DPD to control a transmission or reflectivity of the pixels Pi in accordance with images of the video signal VI to be displayed. The processing circuit DRC further comprises the drive circuit DR which generates the LED currents Li for driving the plurality of LED strings DSi.

It has to be noted that the present invention is not limited to a display apparatus. The advantageous manner of driving strings of LED's may be used for any application in which strings of LED's are used. Such an application may, for example, be a bright light panel.

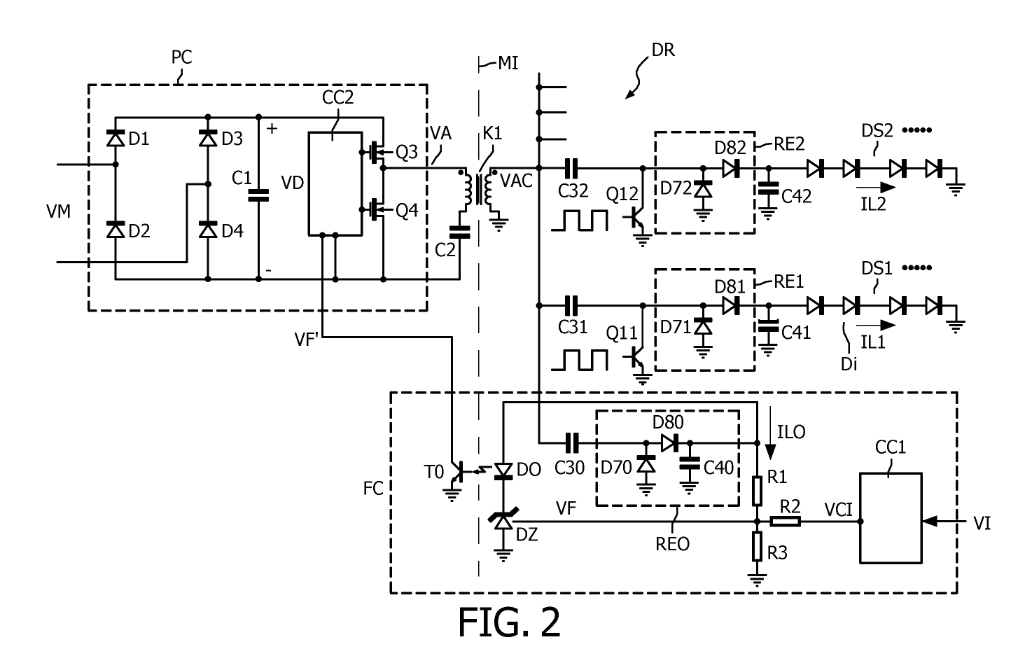

FIG. 2 shows a circuit diagram of an embodiment of a power converter PC, a drive circuit DR for driving LED strings and the LED strings DS1, DS2.

In the embodiment shown, the power converter PC comprises a bridge rectifier D1, D2, D3, D4 which rectifies the AC mains voltage VM to obtain the DC voltage VD. Alternatively, the DC voltage VD may be supplied by a battery and the bridge rectifier D1 to D4 is superfluous. The series arrangement of the electronic switches Q3 and Q4 receives the DC voltage VD. The junction of the series arranged electronic switches Q3 and Q4 is connected to the inductor K1. The controller CC2 controls the switches Q3 and Q4 such that their on and off states alternate in a non-overlapping manner to supply an AC voltage to the resonance inductor K1. Optionally, the controller CC2 is able to vary the switching frequency of the switches Q3 and Q4 in response to a feedback signal VF′. The controller CC2 may be the inverter driver IC UBA 2071. The power converter PC shown in FIG. 2 is an embodiment only, any power converter which is able supply an AC output voltage can be used, such as for example all resonant power converters. In the embodiment shown, the inductor K1 is a transformer with a primary winding which is arranged in series with a blocking capacitor C2. This series arrangement is arranged in parallel with the main current path of the transistor Q4. The transistors Q3 and Q4 are shown to be MOSFET's, however any other electronic switch may be used, such as for example a bipolar switch.

The drive circuit DR comprises the resonance inductor K1, the resonance capacitors C31, C32, the rectifiers RE1, RE2 and the optional feedback circuit FC. In the application shown, the resonance inductor K1 is a mains isolated transformer. However, the mains isolation is optional and the resonance inductor K1 may be a single coil. By way of example, it is shown that the LED strings DS1, DS2 each comprise a series arrangement of 4 LED's. However, the LED strings DS1, DS2 may comprise any number of LED's including only 1. The number of LED's in LED strings DS1, DS2 may mutually differ. In the now following, the series arrangement of the capacitor C31, the rectifier RE1 and the string of LED's DS1 is also referred to as the first branch, and the series arrangement of the capacitor C32, the rectifier RE2 and the string of LED's DS2 is also referred to as the second branch. Each one of the branches is arranged in parallel with the secondary winding of the transformer K1. If the resonance inductor K1 is a single coil, one of its terminals is connected to receive the power supply voltage VA and the branches are connected to the other terminal of the coil.

Optionally, the branches may comprise an electronic switch Q11, Q12 which is connected between a reference voltage, which in the example shown is ground, and the junction of the associated one of the resonance capacitors C31, C32 and the associated one of the rectifiers RE1, RE2, respectively. If a dimming control is desired, the on-time of the switches Q11, Q12 can be controlled with a PWM signal which has a varying duty cycle. During the periods in time the switch Q11 or Q12 is in its on-state, the current is prevented to flow through the associated LED string DS1 or DS2, respectively. During the periods in time the switch Q11 or Q12 is off, the current flows through the associated LED string DS1 or DS2, respectively.

It has to be noted that independent on whether the switches Q11 and Q12 are on or off, the resonant current is always flowing through the resonant capacitors. Consequently, the resonance frequency is not influenced by the state of the switches Q11 and Q12, allowing the resonant supply to work in continuous mode whatever the number of active strings is. This is an advantage over the usual serial switches which each are arranged in series with one of the LED strings.

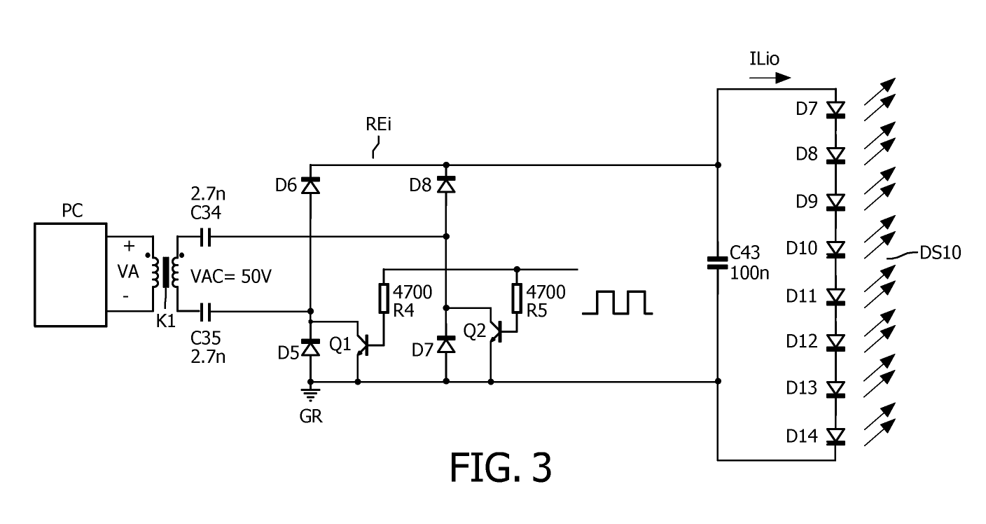

The branches may comprise buffer capacitors C41, C42 which filter the rectified voltage across the LED string DS1 or DS2, respectively. The switch Q11 or Q12 may be arranged in parallel with the associated buffer capacitor C41 or C42, respectively. However, this has the disadvantage that the current through the switch Q11 or Q12 increases because of the discharge current of the capacitor C41 or C42. The number of branches is at least two. Although is shown that the branches are identical, the branches may differ, for example in that the number of LED's differ, in that the switch Q11 or Q12 is not present in a branch wherein no dimming is required, or in that the rectifier circuit RE1, RE2 is a full bridge rectifier as is elucidated with respect to FIG. 3. Such a full bridge rectifier has the advantage that the peak current through the resonance inductor K1 decreases.

The resonance inductor K1 together with the resonance capacitors C31, C32 of all the branches determine the resonance frequency of the driver. If the resonance inductor K1 is a transformer, it is the leakage inductance of transformer K1 together with the resonance capacitors C31, C32 which determines the resonance frequency.

The resonance voltage VAC which occurs at the junction of the resonance inductor K1 and the resonance capacitors C31, C32, should be selected sufficiently high with respect to the forward voltage of the string of LED's DS1, DS2 such that the impedance of the resonance capacitors C31, C32 at the switching frequency of the power converter PC is sufficiently high. In this manner a current source behavior is obtained. This current source need not be ideal. It suffices that the influence of the tolerance of the forward voltage of the LED's on the current IL1, IL2 through the LED strings DS1, DS2 is decreased to a desired level. A desired level may be defined as a percentage, for example, taken the tolerance into account of the LED's used, the current IL1, IL2 through the LED's should not vary more than 10%, 5% or 1%. It has to be noted that the topology of the whole drive circuit DR is independent on the number of branches implemented. Or said differently, the manner in which the circuit operates does not depend on the number of branches. The only important aspect is that the value of the resonance inductor K1 and the resonance capacitors C31, C32 is selected such that the desired resonance frequency results.

The optional feedback circuit FC comprises a resonance capacitor C30, a rectifier circuit RE0, a voltage divider R1, R2, R3, a shunt voltage regulator DZ, an opto-coupler D0, T0, and an optional control circuit CC1.

The series arrangement of the capacitor C30, the rectifier REO and the voltage divider resistors R1 and R3 in fact form a further branch in which the LED string is replaced by the voltage divider resistors R1, R3. Consequently, the current ILO through this branch resembles or mirrors the currents IL1, IL2 through the other branches. The branch with the voltage divider resistors R1, R3 is also referred to as the feedback branch. The capacitor C30 is called resonance capacitor because this capacitor C30 is arranged in the same manner as the resonance capacitors C31, C32 of the other branches and together with these other resonance capacitors C31, C32 determines the value of the total resonance capacitance which together with the resonance inductor K1 determines the resonance frequency. Instead of the voltage divider resistors R1, R3 other impedances may be used than resistors.

The feedback voltage VF at the junction of the resistors R1 and R3 represents the current IL0 through the feedback branch and mirrors the current IL1, IL2 through the LED strings DS1, DS2 of the other branches. This feedback voltage VS determines the current through the opto-coupler diode D0 via the shunt voltage regulator DZ. The shunt voltage regulator DZ becomes conductive when the voltage at its control input reaches a predetermined voltage level. The system is stable (regulated) when the voltage VF on the resistor R3 reaches the predetermined voltage level, thus when the current through the resistor R3 reaches the predetermined voltage level divided by the resistance value of the resistor R3. The opto-coupler transistor T0 supplies a feedback voltage VF′ in accordance with the current through the opto-coupler diode D0. The power supply controller CC2 receives the feedback voltage VF′ and controls the switching frequency of the switches Q1 and Q2 such that the resonance voltage VAC is varied to stabilize the current IL0 through the feedback branch. Consequently, also the currents IL1, IL2 through the branches with the LED strings DS1, DS2 are regulated in the same manner as the current IL0.

The optional feedback controller CC1 receives the video signal VI to supply a control signal VCI via the resistor R2 to the junction of the resistors R1 and R3. The control signal VCI influences the feedback signal VF with the video signal VI and thus controls the resonance voltage VAC in response to the video signal VI.

In an embodiment, the control signal VCI causes the resonance voltage VAC to decrease and thus the currents IL1, IL2 to decrease when is detected in the video signal VI that the amount of high level white in the image(s) to be displayed is high. In this manner the power to be supplied by the power converter PC can be limited if the image comprises relatively large areas of relatively high luminance. In another embodiment, when the controller CC1 detects that the image(s) do not contain high luminance portions, the resonance voltage VAC may be increased to increase the luminance and thus the contrast of the image displayed. Alternatively, any other algorithm for controlling the overall luminance of the images displayed in response to the content of the video signal VI may be used. For example, the well known beam current limiting approach known from CRT display apparatus may be implemented.

FIG. 3 shows an alternative topology of one of the branches comprising a LED string and its association part of the drive circuit. The power converter PC which supplies the AC power supply voltage VA to the resonance inductor K1 may be identical to that shown in FIG. 2. For the sake of simplicity, FIG. 3 shows a single branch which may replace one or more of the branches in FIG. 2. The difference with the branches shown in FIG. 2 is that the rectifier circuit RE1, RE2 of these branches is replaced by a full bridge rectifier REi. To accommodate for the full bridge rectifier REi, the resonance capacitor C31 or C32 has to be replaced by two capacitors C34 and C35 per branch and the electronic switch Q11 or Q12 has to be replaced by two electronic switches Q1 and Q2 per branch. In this manner, the circuit suitable for the one of two phases of the AC voltage as is rectified by the single phase rectifier RE1, RE2 of FIG. 2 has been replaced by two identical circuits, one for each phase of the AC voltage to be rectified. The values of components, indicated in FIG. 3 near the components, belong to an exemplary embodiment suitable for a string of LED's DS10 comprising eight LED diodes in series with a total forward voltage of about 25V and a LED current IL10 of about 20 mA. These values may differ in another implementation.

Again, in this embodiment, the resonance inductor K1 is a transformer of which a primary winding receives the power supply voltage VA and of which the secondary winding supplies the resonance voltage VAC. The full bridge rectifier REi comprises a series arrangement of diodes D5 and D6 which series arrangement is arranged in parallel with a series arrangement of the diodes D7 and D8. The resonance capacitor C34 is arranged between one of the terminals of the secondary winding and a junction of the diodes D7 and D8. The resonance capacitor C35 is arranged between the other one of the terminals of the secondary winding and a junction of the diodes D5 and D6. The interconnected cathodes of the diodes D6 and D8 are connected to the anode of the first LED D7 in the LED string DS10. The interconnected anodes of the diodes D5 and D7 are connected to the cathode of the last LED D14 in the LED string DS10. The LED string DS10 comprises a series arrangement of 8 LED's D7 to D14. A buffer capacitor C43 may be arranged in parallel with the LED string DS10. If dimming is required, the main current path of the electronic switch Q1 has to be arranged in parallel with the diode D5 and the main current patch of the electronic switch Q2 has to be arranged in parallel with the diode D7. In the embodiment shown, the electronic switches Q1 and Q2 are bipolar transistors of which the collector-emitter path is arranged in parallel with the associated diode, and of which the bases are connected to a PWM control signal via the respective resistors R4 and R5. However, any other type of controllable electronic switches can be used.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A drive circuit (DR) for driving a plurality of LED strings (DS1, DS2; DS10) each comprising at least one LED (Di), the drive circuit comprises:
a resonance inductor (K1),
a plurality of branches each comprising a series arrangement of a resonance capacitor (C31, C32; C34, C35) and an associated one of the plurality of LED strings (DS1, DS2; DS10), the resonance capacitor (C31, C32; C34, C35) being arranged between the resonance inductor (K1) and its associated one of the plurality of LED strings (DS1, DS2; DS10) for receiving a resonance voltage (VAC) from the resonance inductor (K1),
wherein a level and frequency of the resonance voltage (VAC) and an impedance of the resonance capacitor (C31, C32; C34, C35) are selected for supplying a LED current (IL1, IL2; IL10) through the associated one of the plurality of LED strings (DS1, DS2; DS10) being substantially independent on a tolerance on forward voltages of LED's of the associated one of the plurality of LED strings (DS1, DS2; DS10).

2. A drive circuit (DR) as claimed in claim 1, further comprising in each one of the plurality of branches a rectifier circuit (R1, R2; Ri) arranged between the resonance capacitor (C31, C32; C34, C35) and its associated one of the plurality of LED strings (DS1, DS2; DS10).

3. A drive circuit (DR) as claimed in claim 2, further comprising an electronic switch (Q11, Q12; Q1,Q2) coupled to a junction of the resonance capacitor (C31, C32; C34, C35) and its associated one of the plurality of LED strings (DS1, DS2; DS10) to withdraw at least a portion of the LED current (IL1, IL2; IL10) from the junction.

4. A drive circuit (DR) as claimed in claim 1, wherein the resonance voltage (VAC) is a same common AC voltage for each one of the resonance capacitors (C31, C32; C34, C35).

5. A drive circuit (DR) as claimed in claim 1, further comprising a power converter (PC) for supplying an AC power supply voltage (VA) to the resonance inductor (K1), and wherein the power converter (PC) has an input for influencing the AC power supply voltage (VA) to control the LED current (IL1, IL2; IL10) through the LED strings (DS1, DS2; DS10).

6. A drive circuit (DR) as claimed in claim 5, further comprising a control circuit (CC) receiving a video signal (VI) to be displayed on a display panel (DP) illuminated by the LED strings (DS1, DS2; DS10), the control circuit (CC1) having an output coupled to the input of the power converter (PC) to control the LED current (IL1, IL2; IL10) in response to the video signal (VI).

7. A drive circuit (DR) as claimed in claim 6, wherein the control circuit (CC1) is constructed for reducing the LED current (IL1, IL2; IL10) when a white content in an image represented by the video signal (VI) exceeds a predetermined level or for increasing the LED current (IL1, IL2; IL10) when a white content in an image represented by the video signal (VI) drops below a predetermined level.

8. A drive circuit (DR) as claimed in claim 1, further comprising a power converter (PC) for supplying an AC power supply voltage (VA) to the resonance inductor (K1), and a feedback circuit (FC), the feedback circuit (FC) comprises:
a feedback capacitor (C30) being one of the plurality of resonance capacitors,
an impedance (R1, R3) for supplying a feedback signal (VF) representative of a current (IL0) through the impedance (R1, R3), and
a rectifier circuit (D70, D80) being arranged between the feedback capacitor (C30) and the impedance (R1,R3),
wherein the power converter (PC) comprises a control circuit (CC2) having an input for receiving the feedback signal (VF) to regulate the AC power supply voltage (VA) in response to the feedback signal (VF).

9. A drive circuit (DR) as claimed in claim 8, further comprising a further control circuit (CC1) receiving a video signal (VI) to be displayed on a display panel (DP) illuminated by the LED strings (DS1, DS2; DS10), the further control circuit (CC1) having an output coupled to the impedance (R1, R3) for influencing the feedback signal (VF) to control the LED current (IL1, IL2; IL10) through the LED strings (DS1, DS2; DS10) in response to the video signal (VI).

10. A drive circuit (DR) as claimed in claim 9, wherein the further control circuit (CC1) is constructed for reducing the LED current (IL1, IL2; IL10) when a white content in a picture represented by the video signal (VI) exceeds a predetermined level, or for increasing the LED current (IL1, IL2; IL10) when a white content in a picture represented by the video signal (VI) drops below a predetermined level.

11. A LED circuit comprising the drive circuit (DR) of claim 1 and the LED strings (DS1, DS2; DS10).

12. A backlight unit (BL) for a display apparatus (DA), the backlight unit (BL) comprises the LED circuit of claim 11.

13. A display apparatus (DA) comprising a display panel (DP) and the backlight unit (BL) of claim 12 for illuminating the display panel (DP).
